(19) United States
(12) Patent Application Publication
(10) Pub. No.: US 2022/0068066 A1
(43) Pub. Date: Mar. 3, 2022

(54) STUDENT LIFE ORGANIZATION, POPULATION AND EMERGENCY MANAGEMENT SYSTEM AND METHOD

(71) Applicant: SchoolSuite, New Haven, CT (US)

(72) Inventors: Jeffrey Francis Pzynski, Salisbury, CT (US); Hilary Ivey Mueller, South Egremont, CT (US)

(73) Assignee: SchoolSuite, New Haven, CT (US)

(21) Appl. No.: 17/411,586

(22) Filed: Aug. 25, 2021

Related U.S. Application Data
(60) Provisional application No. 63/070,117, filed on Aug. 25, 2020.

(51) Int. Cl. G07C 9/28; G07C 9/29; G07C 9/27; H04W 64/00

(52) U.S. Cl. CPC G07C 9/28; G07C 9/29; H04W 64/006; H04W 64/003; G07C 9/27

(57) ABSTRACT

A system tracks students on a campus by giving user devices to each student, and monitoring user device locations on a server on entry of user devices to buildings or classrooms. The server identifies students from user device IDs and updates location data and class attendance data and provides current location reports localized to classrooms for students from the location data. In embodiments, the server can transmit messages to user devices according to location data associated with the students. In embodiments, user devices include barcode readers within each user device with barcodes posted at entrances of buildings and classrooms, GPS receivers in user devices, or nearfield radio transponders.

### CROSS-REFERENCE TO RELATED APPLICATIONS

This document claims priority to U.S. Provisional Patent application 63/070,117 filed 25 Aug. 2020, the contents of which are incorporated herein by reference.

### FIELD OF THE INVENTION

The present invention generally relates to the fields of educational administrative systems and emergency management systems, and more particularly to a singular administrative system for use in an educational setting for coordinating the schedules and movement of students, and for providing notifications, especially in emergency situations.

### BACKGROUND OF THE INVENTION

A day in the life of the modern student, at all levels of education, has dramatically shifted in recent times due to the incorporation of computer systems and digital technology in the educational model, as well as the increased reliance on personal computing devices, cell phones, and tablets. As a result, there are greater data requirements that schools must coordinate and keep track of. Indeed, each student essentially has a unique educational portfolio, accounting for a variety of personalized factors including but not limited to the student's class schedule, assignments, class notes, extracurricular activities, attendance history, disciplinary record, and the like. Additionally, schools must now keep greater track of each student's physical location at all times during the school day, or for an even longer time period for boarding schools, as a result of safety and lockdown protocols due to emergency threats, as well as new societal efforts to maintain proper social distancing due to health concerns.

There has also been a recent shift to more remote or distancing learning for educational institutions from colleges and universities, to high schools and boarding schools, to elementary schools. The new reality is that students, at all educational levels, are likely to mix their learning routine between traditional on-site class attendance and meetings with remote learning, performance and evaluation. As students transition more of their daily routine online, educational institutions have had to adapt to be able to provide and receive information and materials to and from the students through online platforms. Additionally, such educational institutions have had to adapt to be able to evaluate student progress and coordinate important metrics through less “traditional” means. For example, many online tools are available for providing and exchanging class assignments and materials, including but not limited to BlackBoard, Microsoft Teams, School Pass, and the like.

However, with students spending more time learning “on-line”, schools must also find better and more accurate means of being able to “track” the students, both in an educational progress sense as well as in a physical sense. For the former concept, schools must be able to keep track of a student's assignments, test scores, individual development, attendance history, and disciplinary history. As a result, a means of keeping track of this information and more is critical to a student's success through the school year.

Similarly, schools must also be able to keep track of a student's physical whereabouts—i.e., are they at home working remotely or are they on campus, or are they off-campus on a trip. This data is valuable in emergency situations, as noted above, such that should a lockdown procedure be in effect, a school can determine where everyone on campus is located. This information is also valuable even in the educational context, as schools can determine whether students are abiding by school protocols, maintaining good and timely attendance, and comporting with disciplinary guidelines.

While there are many systems current available for coordinate the educational aspects of a student's daily routine, such existing systems are insufficient for coordinating all aspects of a student's routine or addressing the disjointed issues that generally surround student life population management. Notably, there is no centralized solution available for providing real-time information on the whereabouts of students on campus. Additionally, there should be a system that not only identifies each student's location when on campus, but also can account for students learning remotely versus being physically on campus. Further, there is no adequate centralized system, for communicating with an entire school community in an emergency situation (including students, faculty, staff, parents, etc.). Existing systems are antiquated and have limited functionality for real-time attendance and location monitoring. Further, existing systems, while beneficial between an individual student and a specific class/teacher, lack effective communication and coordination means between students and administration across the entire school and facilities platform. Moreover, schools have had to have multiple systems to know where students are at any given time, manage how a student comes and goes from campus to school, and manage permissions with student movements on and off campus, day trips as well as overnights/vacations, missing school, studying remotely or online, etc.

In view of the foregoing, there is a need for a student life organization, population and emergency management system and method for use in educational systems of all sizes and designs. Further, there is a need for a system that can be easily integrated into a school's database that permits management of a student's presence on a school's campus, attendance throughout a school day, schedule, assignments, and notification. Still further, there is a need for a system that can monitor each student's physical location on campus to facilitate emergency alerts and responses, as necessary. Accordingly, it is a general object of the present invention to provide such a system and method that improves upon conventional student life organization, population or emergency management systems and methods used in the marketplace and that overcomes the problems and drawbacks associated with such prior art systems and methods.

### BRIEF DESCRIPTION OF THE FIGURES

Features and applications of the present invention are described with reference to the drawings of preferred embodiments of a unified system for tracking staff, students and faculty on and around a campus environment. The illustrated embodiments of features of the present invention are intended to illustrate, but not limit the invention.

FIG. 1 is a block diagram of an embodiment of a unified system for tracking staff, students and faculty on and around a campus.

FIG. 2 is a block diagram of an embodiment of an alternate system for tracking staff, students, and faculty on and around a campus.

FIG. 3 is a flowchart of operation of the embodiment of FIG. 1.

FIG. 4 is a flowchart of operation of the complex user device embodiment of FIG. 1.

FIG. 5 is a flowchart of operation of the embodiment of FIG. 2

FIG. 6 is a campus diagram showing placement of QR tags or near-field transceivers for tracking students on the campus

### DETAILED DESCRIPTION OF THE EMBODIMENTS

### Overview

In accordance with the present invention, an operation, population and emergency management system and method for monitoring educational progress and coordinating movement of a plurality of students in an educational system is provided. Given recent concerns over student safety and public transmission of diseases and viruses requiring proper social distancing, combined with a shift toward online and remote learning with an increased prevalence of digital devices in the educational set-up, a real-time student life protocol is advantageous in educational environments of all levels and sizes. Such a system is especially useful in colleges, universities, high schools and boarding schools, where a school needs to monitor and coordinate the schedules, production and physical locations of numerous students. In accordance with the present invention, a system and method is provided to integrate and coordinate each student's personalized schedule, assignments, and routine history (e.g., attendance, disciplinary, and the like) with geo-location, positioning and mapping means. This enhances day-to-day operation of the school to be able to provide the best educational experience for each student, but also to provide great value should any emergency situations arise on campus (e.g., active shooter, fire, earthquake, individualized threats, etc.).

In an embodiment of the present invention, the organization, population and emergency management system can have a personalized app component that self-adjusts to each individual's role and specific functional tasks (e.g., student, faculty, staff, parent, visitor, etc.) and a centralized dashboard for management and monitoring purposes. The dashboard can be web-based, and is generally associated with school administrative functioning. Additionally, the system may be integrated into a school's existing Student Information System (SIS), eliminating the need to manage multiple database. As a result, all relevant contact information (such as email, phone numbers, addresses, class schedules, class rosters, sport rosters, advisors, attendance, events, etc.) can be aggregated in a single, centralized database and utilized in connection with monitoring and tracking of individuals.

In operation in accordance with the present invention, individuals can check-in to the system—for example, through a sign-in or a scan-in—which can provide permission and approval for the system to keep track of the user's whereabouts, schedule, and details about certain school events for the individual. Individuals may also be able to access their own information, such as class schedule, assignments, events, sport schedule, school notice, and the like, and can further provide permission for others to view their information (such as parents, teachers, administrators). Further, messages can be sent or pushed to individuals that are checked in. In this regard, the system provides two-way data exchange. Further, the system is able to account for the full school-wide population with manual location information, as well as geolocation for validation.

In another aspect of the present invention, communication between individual, groups, or across the entire school is available, such as by app messaging. Further, access to information and data on one individual's personal portfolio can be shared with other designated individuals, as desired. the general overall architecture of an organization, population and emergency management system in accordance with the present invention is illustrated.

In general, the present system and method can be used with an educational system, such as a school. It is useful for schools of all types and sizes, including but not limited to colleges and universities, high schools, boarding schools, and lower grade and elementary schools. Additionally, the system and method of the present invention can be used in similar settings, including but not limited to nursing homes or assisted living facilities, addiction treatment facilities, jails or juvenile detention facilities, offices, or government facilities. As illustrated individuals can be defined by their individualized “role” and be provided with a profile associated with specific functional tasks associated with such role—e.g., students, faculty, staff, administration, parent, visitor, and the like. Each profile is connected with a centralized hub or database on a server. In the school-setting, this hub provides a web-based administration dashboard which can be accessed by authorized individuals, such as through a personalized device provided with an app, or via the Internet. The hub can also communicate with individualized profiles—for example, provide notifications, messages or alerts.

Credentials can be created for faculty, staff and other administration, as appropriate. Referring to Student Credentials, each Credential is linked to specific identifying information for the student—namely, name, home address, email, contact phone, date of birth, school year, etc. Further, each student's Credential is linked to the student's class schedule, extracurricular activities, sports, and the like.

In today's school environments, most students have their own digital devices, such as a laptop computer, a smart phone and/or a tablet. These means are used for communication purposes—e.g., calls, emails, and texts—but also provide a means for students to access class assignments, texts, workbooks, etc.; to take notes, study and do research; communicate and coordinate with teachers; and to also turn-in assignments, test answers, etc. The system of the present invention provides a real-time portal between students and their personalized daily routine. It also provides the school administration a means to check in on the student's progress and educational history, but also their real-time physical location, attendance history, and disciplinary history. In this regard, the student's personal device can be used to have the student “check-in” to the system as a means for keeping track of the student's location, as well as to match the student's actual location with the student's schedule and verify that he or she is where he or she is supposed to be. Upon such “check-in”, the system can update the individual's “status”—providing a real-time means for locating every individual on campus during all times. This is useful in case of emergency situations, allowing for the school to account for everyone's whereabouts, provide time-appropriate alerts, and allocated emergency-response resources as necessary and appropriate.

The organization, population and emergency management system includes a personalized app component that self-adjusts to each individual's role and specific functional tasks (e.g., student, faculty, staff, parent, visitor, etc.). For example, the app may be loaded onto a student's phone, tablet and/or computer. The student can sign-in to see information associated with the student's school year and curriculum, such as daily class schedule, assignments, sports or extracurricular activities, special events, class trips, days off/vacations, and the like. Further, a student can modify his or her specific schedule with additional notations, meetings, deadlines or new events. Further, parents can be provided access to the system through an individualized app which linked to a particular student's profile.

The app provides similar functionality for faculty and staff. For example, a teacher's profile can provide a means to review class attendance, provide and receive tests and assignments, track disciplinary information, provide notices and updates automatically broadcast to students about class schedules.

The system includes a centralized dashboard accessible to staff for management and monitoring purposes. The dashboard can be web-based, and is generally associated with school administrative functioning. Additionally, the system may be integrated into a school's existing Student Information System (SIS), eliminating the need to manage multiple databases. As a result, all relevant contact information (such as email, phone numbers, addresses, class schedules, class rosters, sport rosters, advisors, attendance, events, etc.) are aggregated in a single, centralized database used in connection with monitoring and tracking of individuals.

In operation in accordance with the present invention, individuals can check-in to the system—for example, through an online sign-in or a scan-in using QR codes—which can provide permission and approval for the system to keep track of the user's whereabouts, schedule, and details about school events for the individual. Individuals may also be able to access their own information, such as class schedule, assignments, events, sport schedule, school notice, and the like, and can further provide permission for others to view their information (such as parents, teachers, administrators). Further, messages can be sent or pushed to individuals that are checked in. In this regard, the system provides two-way data exchange. Further, the system accounts for the full school-wide population with manual location information, as well as geolocation for validation.

The system comprises a full population management system that coordinates class schedules, assignments and disciplinary information, and also incorporates event management and emergency management with integrated attendance functionality. This integration may include manually-entered location information, as well as geo-location, for validation purposes so that in emergency situations the location of every person on campus or within a particular building or section of a building can be easily accounted for and appropriate actions can be taken, including sending or alerts, messages, or instituted responsive actions, to ensure safety of all individuals. In some embodiments, geo-location or tracking functionality is strictly for identifying location data and facilitating contact with individuals in emergency situations without impinging upon individuals' privacy concerns, while other embodiments (such as those used in reform schools) may automatically update behavior and disciplinary records.

The system has communication tools, for example, from individuals to the centralized hub, form the centralized hub to individuals, and between individuals (i.e., student-to-student, teacher-to student, student-to-teacher, teacher-to-teacher, administration-to-student, student-to-administration, administration-to-teacher, teacher-to-administration).

The present invention, though described in the context of educational systems, can be used in other areas where a group of collected people may have individualized daily schedules and further whether there is a need to monitor and track on-site location and “coming and going” activity. For example, such a system could be used in nursing homes, assisted living hospitals, stay-away camps, prisons, juvenile detention or treatment facilities, and the like.

### Hardware

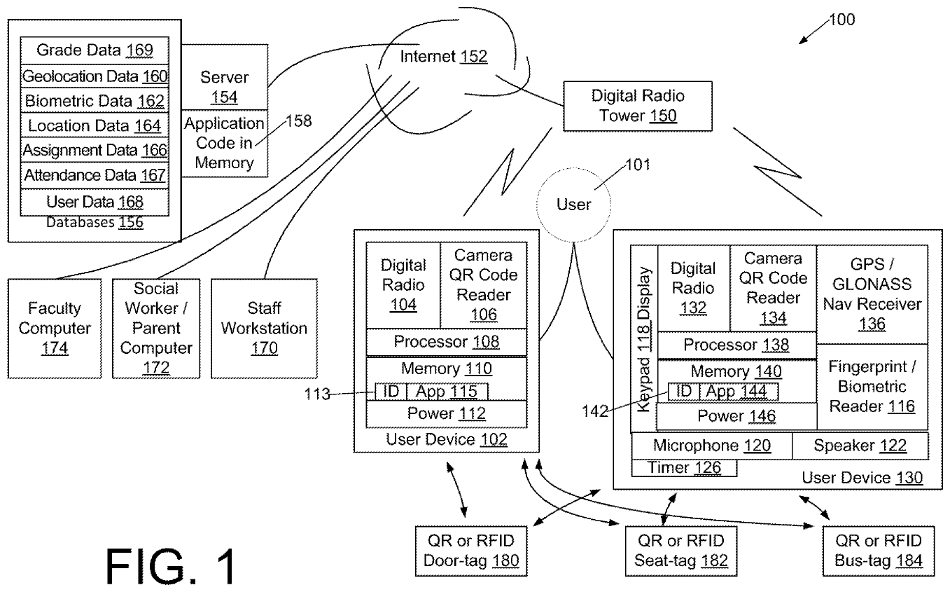

In an embodiment 100 (FIG. 1) a first embodiment of a user device 102 is issued to, and carried by, a user 101 who may be a staff member, student, or faculty associated with a particular campus. User device 102 incorporates a digital radio 104, a location identifying device that in an embodiment is a camera configured as a quick response (QR) code (a form of barcode), or other barcode, reader 106, a processor 108, a memory 110, and a power supply 112. The memory incorporates a unique user device identification 113 and application code 115.

An alternative embodiment of a user device 130, issued to and carried by a user 101, also has a digital radio 132, location identifying devices that in embodiments include one or more of a camera configured as a quick response (QR) code, or other barcode, reader 134, a global positioning system (GPS) receiver 136 that may also be configured to receive location information from the Russian Global Navigation Satellite System (GLONASS), a processor 138, a memory 140, and a power supply 146. The memory incorporates a unique user device identification 142 and application code 144. In some embodiments, user device 130 also incorporates one or more of a microphone 120, speaker 122, timer 126, keypad 118 with display, and a biometric reader 116 such as a fingerprint reader 116 or camera configured to obtain facial photographs suitable for face recognition.

In a particular embodiment, user device 130 is a smart cellular telephone configured with application code 144.

Digital radios 104, 132 are in contact with a digital radio tower 150 that may be a cellular telephone system tower; digital radio tower 150 relays communications received through digital radios 104, 132 from user devices 102, 130 through the internet 152 to a server 154 that maintains databases 156 under control of database and application code in memory 158.

Staff workstations 170, parent computers 172, and faculty computers 174 may also communicate over the internet 152 to server 154.

In embodiments, QR codes, or near-field radios that can be interrogated by digital radios 104, 132, are provided at doors 180 of classrooms and entrances to the campus, at individual seats 182 during examinations, and separate tags may be provided for entrance and exits of campus-related busses 184.

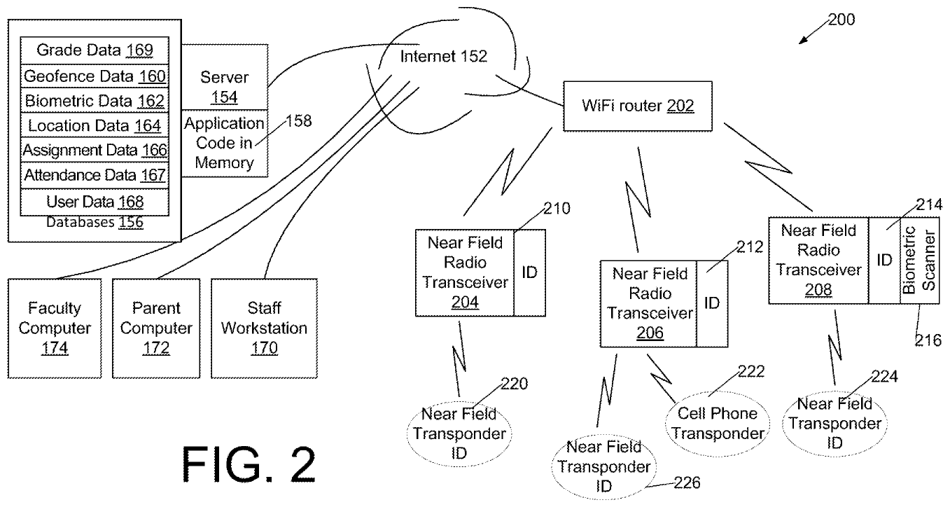

In an alternative embodiment 200 (FIG. 2), internet 152, server 154 that maintains databases 156 under control of database and application code in memory 158, staff workstations 170, parent computers 172, and faculty computers 174 are essentially similar to those shown in FIG. 1, however user devices are based on near-field radios, not on cellular telephone-compatible devices. In this embodiment, an IEEE 802.11-compatible “WiFi” router 202 couples to internet 152 and is linked to a WiFi digital radio of near-field transceivers 204, 206, 208; each near-field transceiver having a unique identification 210, 212, 214. Some near field transceivers, such as transceiver 208, may also be equipped with biometric readers 216. Each user is issued a near-field transponder 220, 224, 226 having a unique identification. We note that some complex user devices 130, including some smart cellular phones, have multiple, flexible, digital radios that can respond to interrogation by near-field transceivers 204 and may be used with this system as transponder 222.

In an embodiment, student logins to educational programs are tracked, with. internet protocol (IP) addresses used to distinguish between logins from within a school campus from logins from telecommuting students off the campus. These logins are transmitted by each machine being accessed by a student to server 154 and logged in attendance data 167 with logins from telecommuting students off the campus logged as such in location data 164.

In embodiments, server 154 may also manage, as part of databases, both student and faculty calendars as part of assignment data.

### Operation

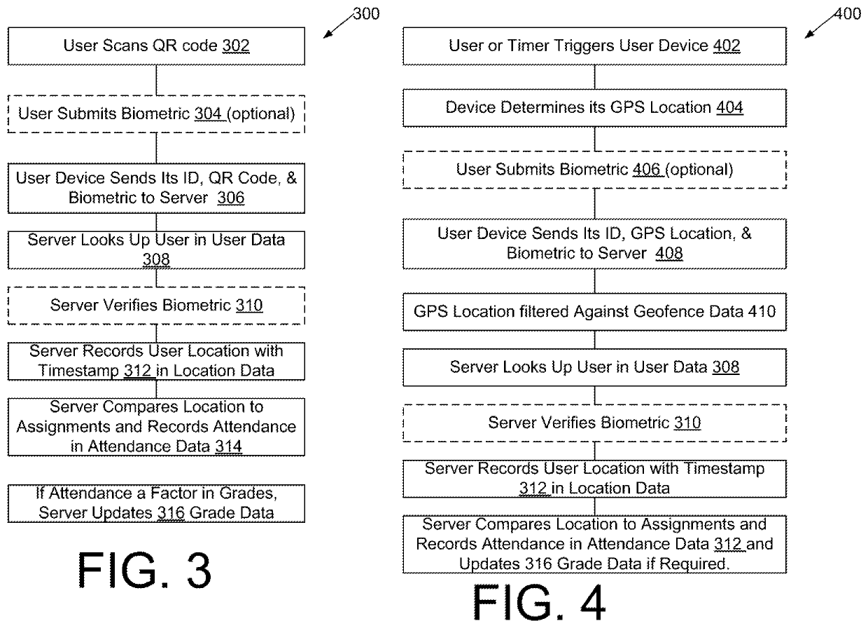

Embodiments 100 of FIG. 1 using QR codes operate according to method 300 (FIG. 3). On entry to the campus, or on entry to a particular room within the campus such as a classroom, the user positions user device 102, 130 so camera QR code reader 106, 134 can capture a QR code attached to, or near, a door or other entry of campus or classroom. Since students have a high likelihood of attempting to cheat, for enhanced security as may be required for examinations, the user also submits 304 a biometric, such as a selfie photo for use with facial recognition captured by camera QR reader 106 or a fingerprint scan captured by fingerprint/biometric reader 116. The user device formats and sends 306, using digital radio 104, 132, messages containing the ID 113, 142 recorded in memory 110, 140, information from the QR code, and the biometric (if required) to server 154. Server 154 then looks up 308 the user in user data 168, verifies the biometric 310 in biometric data 162, and records 312 the user as present at that door or entry in location data 164. If the door or entry is a door or entry to a classroom, and the user is a student, server 154 looks up classroom assignments in assignment data 166 and records 314 the user as present in attendance data 167 for each class. Where attendance is considered a part of student grades, the server may also update 316 grade data 169 accordingly. Similarly, attendance and students failing to be present in dorm rooms during designated quiet times, or failure to attend assigned classes, can be automatically entered into a behavior or disciplinary record on server 154 by an automatic review on server 154 of location data history, assignment data and attendance data.

Embodiments 100 of FIG. 1 using GPS locations with user device 130 operate according to method 400 (FIG. 4). When either an optional timer 126 of user device 130 expires, or the user triggers 402 the user device 130, the user device uses GPS and/or GLONASS-compatible satellite navigation system receiver 136 to determine 404 its location, and, if a biometric is required, obtains 406 a biometric, such as a selfie photo for use with facial recognition captured by camera QR reader 106 or a fingerprint scan captured by fingerprint/biometric reader 116. The user device then sends 408 its identification, GPS location, and biometric to server 154. The server 154 filters 410 the user device's GPS location against geolocation data 160 to determine whether the location is on or off of a campus, and whether the GPS location corresponds to any particular building and/or classroom on the campus. The server 154 then proceeds as in method 300 by looking up 308 the user in user data 168, verifying the biometric 310 in biometric data 162, and recording 312 the user as present at that location in location data 164. If the location is a classroom, and the user is a student, server 154 looks up classroom assignments in assignment data 166 and records 314 the user as present in attendance data 167. Where attendance is considered a part of student grades, the server may also update 316 grade data 169 accordingly.

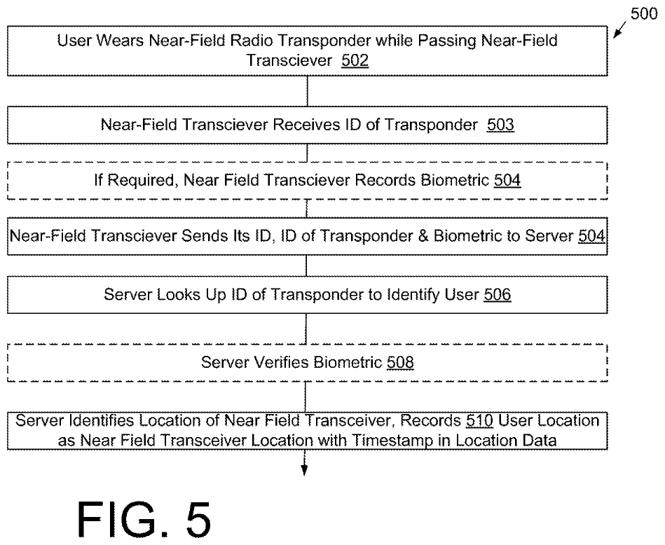

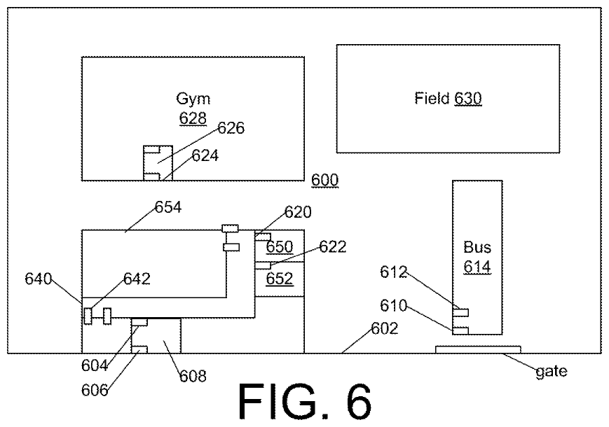

An embodiment according to FIG. 2 operates according to method 500 (FIG. 5). Method 500 begins with each user assigned a near-field transponder 220, 222, 224, 226 wearing 502 it while passing near-field transceivers 204, 206, 208 that may be positioned at entrances to, and exits from, the campus and entrances to particular classrooms of the campus. Each transceiver interrogates passing transponders and receives 503 from them a transponder identification (ID) of that transponder. If required for enhanced security, such as in examinations, each transceiver also records a biometric, such as a facial mugshot for facial recognition or a fingerprint for fingerprint recognition from the user; then the transceivers send messages containing their own ID, the ID of the transponder, and the biometric to server 154, Server 154 looks up 504 the ID of the transponder to identify the associated user and, if a biometric is required at that particular transceiver, verifies the biometric. Server 154 then records the user as at a location of the transceiver in location data 164 and continues as previously described with reference to steps 314 and 316.

Faculty computers 174, social worker and/or parent computers 172, and staff workstations 1.70 may in embodiments have varying authorizations to request reports be generated by server 154 from data in databases 156. For example, a social worker and/or parent computer 172 may request reports of student grades and attendance in classrooms or absence from campus with access limited to students for whom they have governmental or parental authority. Faculty computers 174 may access reports of student attendance for students in the classes they teach, and may generate reports of, enter, and update grade information. Staff computers are configured with apps that can request reports of current locations of all students and faculty, including an inventory of those present in each classroom, auxiliary building, and dormitory throughout the campus, during lockdown events. Staff computers can also generate reports of student attendance and grade information for all students in a school.

Staff computers are further configured in some embodiments, such as embodiments where user devices are cell phones or other devices with displays, to transmit text messages to user devices associated with students according to the location data, such as to user devices of all students having current locations in a particular selected classroom, building wing or floor comprising multiple classrooms, auxiliary building, or dormitory while optionally sending different messages to students having different locations. This feature may prove useful in sequencing evacuation of students from particular areas on campus during emergencies.

### Securing a Campus

A campus 600 may be secured, and students tracked, by erecting a boundary fence 602 and positioning either entry and exit QR codes or nearfield radio transceivers 604, 606 in the building entrance lobby 608. if QR codes are used, students are required to scan either a building entry or a building exit, as appropriate, QR code when entering or leaving the building. With nearfield radio transceivers at an exterior doorway 606 and an interior 604 doorway of the lobby 608, a time difference between reading of nearfield transponders worn by students by each. nearfield transceiver may be used to determine whether students are entering or leaving the building and campus; if the interior doorway transceiver detects a transponder before the exterior doorway transceiver does, then the student is determined to be leaving the building and campus while if the exterior doorway transceiver detects the transponder before the interior doorway transceiver does then the student is determined to be entering the building. Alternatively, short range nearfield radio transceivers may be tapped by entering and leaving students, and students may be required to scan QR codes with their user devices 102, 130 on entry or exit from the building and campus.

Additional entry and exit QR codes or short-range tap-on nearfield radio transceivers for entry 610 and exit 612 are provided at entrances to busses 614 to track entry and exit of busses used for bringing students to or from campus, for field trips, and sporting activities to record student presence on busses; these nearfield radio transceivers 610, 612 may be linked to server 154 by cellular moderns to permit server 154 to track student entry and exit from busses 614 in real time. Additional QR codes or nearfield radio transceivers 620, 622 are provided at entrances to each classroom 650, 652 to gather student attendance and presence data and transmit that data to server 154. Similarly, QR codes or nearfield radio transceivers 624 are positioned at entrances 626 to each auxiliary building on the campus such as a gym 628; these may be provided in pairs as described with reference to QR codes and nearfield radio transceivers at the entrance lobby 608. Students on field 630 can be determined as those tracked leaving buildings from doorways 640 within fence 602 but not tracked entering buildings.

With embodiments using more complex user devices 130 embodying GPS receivers 136, students may be localized to classrooms and auxiliary building by comparing the GPS location last received from user devices 130 to locations recorded for each classroom 650 652, main building 654, and auxiliary building 628 in geolocation data 160.

Students may also be tracked to dorms or to individual dorm rooms if QR codes, nearfield radio transceivers, or GPS-equipped user devices are provided at each dorm as described above for buildings and classrooms.

In addition to tracking students at building entrances, on and off busses, and into classrooms, the system herein described can track students on arrival at events both on and off campus. This may be done with the embodiment of FIG. 1 by printing additional QR barcodes, or other barcodes, placing these at event entrances and exits, and requiring students to scan the codes as they enter or leave the event. The server may review student and faculty calendars in the assignments data and verify event attendance versus planned attendance, and, where event attendance was mandatory, provide lists of those who should have, but did not, attend.

Part of assignments data is a student calendar for each student, including a schedule of classes to which the student is assigned and events the student is expected to attend. Students may access this calendar to view their schedule, and may make additions of personal events to that student's schedule.

Students may also enter into their student calendar of assignments data a request for a day pass or longer excused leave; the server will then message staff, and in some embodiments parents, with the request and, if the request is granted, enter the day pass or excused leave into that student's schedule. The server is configured to generate attendance reports for each class or event that indicate a first group of students who were tracked as present, a second group of students not tracked as present but on a day pass or longer excused leave, and a third group of students absent without leave.

For critical classes, exams, and events, the server is configured to permit a faculty member to override attendance as recorded by tracking students, and manually enter attendance.

The foregoing description of embodiments of the present invention has been presented for the purpose of illustration and description. It is not intended to be exhaustive or to limit the invention to the form disclosed. Obvious modifications and variations are possible in light of the above disclosure. The embodiments described were chosen to best illustrate the principles of the invention and practical applications thereof to enable one of ordinary skill in the art to utilize the invention in various embodiments and with various modifications as suited to the particular use contemplated.

What is claimed is:

1. A system adapted to track students on a campus comprising:
a user device provided to each student;
apparatus for reporting location of user devices to a server configured to send reports to the server on entry of user devices to buildings or classrooms;
the server configured to identify users including students from user device identifications and to update location data and class attendance data associated with students upon receiving location reports from user devices assigned to those students; and
the server configured to provide current location reports for all students from the location data, the current location reports including reports of students present in particular classrooms.

2. The system of claim 1 where the server is further configured to update grade data where attendance is considered in grades.

3. The system of claim 2 where the server is further configured to transmit messages to user devices according to location data associated with the students.

4. The system of claim 3 where the apparatus for reporting location of user devices comprises a barcode reader within each user device, and a plurality of barcodes posted at entrances of buildings and classrooms on the campus, with the user devices configured to send scanned barcodes to the server.

5. The system of claim 3 where the apparatus for reporting location of user devices comprises a global positioning system (GPS) receiver within each user device, with each user device configured to send locations determined by the GPS receiver to the server.

6. The system of claim 5 where the server is configured to identify user devices in particular buildings and classrooms on campus by comparing locations determined by GPS receivers to geolocation data.

7. The system of claim 3 where the apparatus for reporting location of user devices comprises a nearfield radio transponder in user devices and a plurality of nearfield radio transceivers disposed at a plurality of locations on the campus.

8. The system of claim 6 wherein the server is configured to distinguish entry and exit of users from buildings on the campus from time differences between detections of user devices at paired nearfield radio transponders.

9. The system of claim 1 where the server is further configured to provide parental reports of student attendance.

10. The system of claim 1 where at least one bus is configured with apparatus for reporting location of user devices.

11. A method of tracking students on a campus comprising:
issuing a user device having a user device identification to each of a plurality of students;
reporting location of user devices to a server on entry of user devices to buildings or classrooms;
identifying students from the user device identifications and updating location data and class attendance data associated with students; and
providing current location reports for all students from the location data, the current location reports including reports of students present in particular classrooms.

12. The method of claim 11 further comprising updating grade data.

13. The method of claim 11 where the server is configured to transmit messages to students according to location data associated with the students.

14. The method of claim 11 where reporting location of user devices comprises using a barcode reader within each user device to read barcodes posted at entrances of buildings and classrooms on the campus.

15. The method of claim 11 reporting location of user devices comprises using a global positioning system (GPS) receiver within each user device.

16. The method of claim 15 where the server is configured to identify user devices in particular buildings and classrooms on campus by comparing locations determined by GPS receivers to geolocation data.

17. The method of claim 11 reporting location of user devices includes interrogating a nearfield radio transponder in user devices by nearfield radio transceivers disposed on the campus.

18. The method of claim 17 further comprising distinguishing entry and exit of users from buildings on the campus from time differences between detections of user devices at paired nearfield radio transponders.

19. The method of claim 11. where the server is further configured to provide parental reports of student attendance.

20. The method of claim 11 where the attendance data is integrated into a student-modifiable event calendar recorded on the server.
